(19) United States
(12) Patent Application Publication
(10) Pub. No.: US 2010/0282715 A1
(43) Pub. Date: Nov. 11, 2010

(54) METHOD AND APPARATUS FOR CONVERTING A MIG WELDER INTO A CARBON-ARC CUTTER

(75) Inventors: Darryl Hammock, Brighton, MI (US); Raymond A. Kantola, Brighton, MI (US)

Correspondence Address: GIFFORD, KRASS, SPRINKLE,ANDERSON & CITKOWSKI, P.C, PO BOX 7021, TROY, MI, 48007-7021, US

(73) Assignee: Weld Mold Company

(21) Appl. No.: 12/775,733

(22) Filed: May 7, 2010

Related U.S. Application Data
(60) Provisional application No. 61/176,359, filed on May 7, 2009.

(51) Int. Cl. B23K 9/00; B23P 17/04; B32B 9/00

(52) U.S. Cl. 219/69.1; 29/401.1; 428/367

(57) ABSTRACT

Apparatus and methods convert a MIG welder into an effective cutting machine. A hand-held unit and a feeder supply a wire through the hand-held unit, the wire including a carbon-containing core. A source of electrical energy is connected to the wire being fed and the metal to be cut such that an arc is created with sufficient energy to melt the metal in a localized region, and further apparatus is included for directing a gas to blow away the molten metal. The gas may be air or oxygen. A feedstock for metal cutting operations according to the invention contains a roll of wire having a mild steel jacket and a carbon-containing core. The carbon in the core of the wire may be provided in the form of natural or synthetic graphite powder, and may further include an additive to accelerate delivery force or enhance molten metal flow.

### REFERENCE TO RELATED APPLICATION

This application claims priority from U.S. Provisional patent application Ser. No. 61/176,359, filed May 7, 2009, the entire content of which is incorporated herein by reference.

### FIELD OF THE INVENTION

This invention relates generally to welding and, more particularly, to apparatus and methods for converting a MIG welder into an effective cutting machine.

### BACKGROUND OF THE INVENTION

MIG (Metal Inert Gas) welding is a semi-automatic or automatic arc welding process in which a continuous and consumable weld wire 108 and a shielding gas 112 are fed through a torch unit 100, depicted schematically in FIG. 1. The process generates heat from an electric weld arc 110 maintained between the consumable weld wire 108 and base material 114. A constant voltage, direct current power source is most commonly used, but constant current systems, as well as alternating current, can be used.

The heat generates a weld puddle 118, depositing a weld bead 116 onto the part 114. The weld wire 108 is delivered through a contact tip 106, whereas the shielding gas 112 is delivered through a gas diffuser 119 contained within a removable nozzle 104 coupled to torch neck insulator 102. Although nozzle 104 is depicted as a simple cylinder, other shapes may be provided for different purposes. A user-operated control (not shown) on the torch unit 100 simultaneously starts the flow of the shielding gas and activates the advancement of the wire feed from a remote roll.

While the MIG process is well suited to joining certain non-ferrous metals, it is poor at cutting. At least one attempt has been made to convert a MIG welder into a better cutting machine. U.S. Pat. No. 5,021,624 describes an attachment coupled to a source of oxygen and includes a manual control for the jet of oxygen used to oxidize and thereby cut the metal. To initiate the cutting action, an electric arc is first established for a short time to sufficiently locally heat the metal so that rapid oxidation will proceed without any further outside source of energy. Thereafter, the oxygen jet directed at the heated metal is turned on and the electric arc turned off or extinguished, with cutting then proceeding at a rapid rate using only the oxygen jet to both oxidize the metal as a source of heat and blow away molten metal to provide a clean, readily controllable cut. The apparatus uses “normal welding wire” as the feedstock.

### SUMMARY OF THE INVENTION

This invention is broadly directed to apparatus and methods for converting a MIG welder into an effective cutting machine. The apparatus includes a hand-held unit and a feeder operative to supply a wire through the hand-held unit, the wire including a carbon-containing core. A source of electrical energy is connected to the wire being fed and the metal to be cut such that an arc is created with sufficient energy to melt the metal in a localized region, and further apparatus is included for directing a gas to blow away the molten metal. The gas may be air or oxygen.

According to a preferred embodiment, the hand-held unit, feeder and source of electrical energy form part of an existing metal-inert-gas (MIG) welder. The gas may be supplied through a body that clamps onto the hand-held unit of an existing metal-inert-gas (MIG) welder.

The carbon in the core of the wire may be provided in the form of natural or synthetic graphite powder. An additive may be included in the core of the wire to accelerate delivery force or enhance molten metal flow. The wire core may be surrounded with a mild steel jacket.

A feedstock for metal cutting operations according to the invention contains a roll of wire having a mild steel jacket and a carbon-containing core. The carbon in the core of the wire may be provided in the form of natural or synthetic graphite powder, and may further include an additive to accelerate delivery force or enhance molten metal flow.

A method aspect of the invention for converting a metal-inert-gas (MIG) welder into an efficient cutting machine, comprising the steps of: removing the gas shield from the hand-held unit of the welder, exposing the contact tube; positioning a body on the contact tube that direct a gas outwardly away from the hand-held unit; replacing the welding wire of the welder with a wire having a carbon-containing core; and energizing the welder such that a cutting arc is established between the wire and metal to be cut, with the gas being used to blow away molten particulates.

### BRIEF DESCRIPTION OF THE DRAWINGS

FIG. 1 shows a gas nozzle being removed from the MIG torch unit of a welder;

FIG. 2 is a drawing of an air block placed over a contact tip, the device including a body with an attachment bore sized to the contact tip and a manual fastener used to clamp the body in position; and

FIG. 3 is a side view that shows the inventive improvement in position during use.

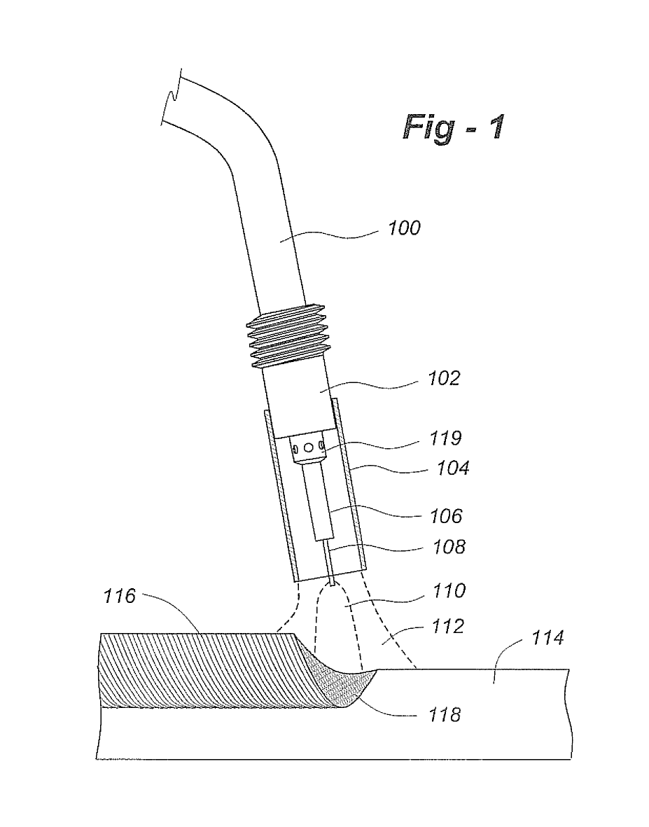

### DETAILED DESCRIPTION OF THE INVENTION

This invention provides apparatus and methods for converting a MIG welder into an effective cutting machine. Unlike the invention described in the '624 patent, this invention does not use “normal welding wire.” Rather, the welding wire is replaced with an inventive wire containing a core with carbon powder. As such, the arc generates considerably more heat, akin to that achieved with a carbon arc cutter. The heat generated is sufficiently high to cut stainless steel and other difficult metal with compressed air, although oxygen may alternatively be used to even greater effectiveness.

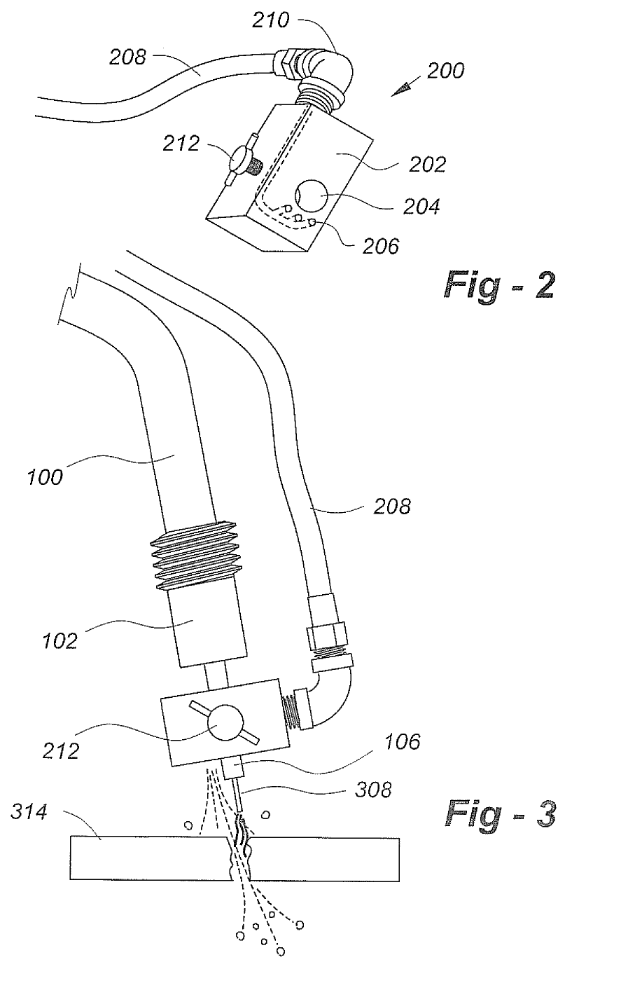

According to the invention, the gas nozzle 104 is removed from the MIG torch unit of the welder and the air block 200 shown in FIG. 2 is placed over the contact tip 106. The device 200 includes a body 202 with an attachment bore 204 sized to the contact tip, with a manual fastener 212 being used to clamp the body in position.

The body 202 includes a gas/air inlet line 208 coupled to the body through a fitting 210. Although a right-angle fitting is shown other connectors may alternatively be used. Cavities formed in the body 202 allow the gas or air to exit through ports 206, preferably substantially parallel to the axis of attachment bore 204. Although three ports 206 are shown on one side, other arrangements are possible, including ports surrounding attachment bore 204.

FIG. 3 is a side view that shows the inventive improvement in position during use. A high-temperature arc is created by wire 308, with air from the ports being operative to blow away molten metal particles. In operation, the gas to the body 202 may be turned on in advance, with the user-operated control on the welder hand unit being used to advance the wire 308 during the cutting process. Alternatively, an electrical circuit may be provided to turn on the gas automatically when the hand unit control is activated.

As mentioned, normal welding wire is not used in accordance with the invention. In particular, the wire used is a composite cored wire comprising a mild steel jacket surrounding a core of compacted high-energy carbon powder. The carbon may be supplied in the form of natural or synthetic graphite (coke), preferably in the range of 30-200 mesh. So-called ‘air-floated’ graphite may be used in the 325-400 mesh range.

The graphite carbon provides the necessary electrical resistance to achieve cutting temperatures comparable to those seen in carbon-arc cutting. Additives may also be used to enhance effectiveness. For example, iron oxide or iron carbonate (i.e., in the 200-mesh range) may be added to accelerate delivery force. Aluminum or magnesium powder additives (i.e., in the 30×200 mesh range) may also provide a beneficial accelerant effect. Fluorides such as calcium or sodium fluoride (i.e., in the 30×325 mesh range) may enhance metal “flow” by lowering surface tension.

The product and process offer distinct advantages over the use of standard carbon or graphite electrodes. Such advantages include the following:

The ability to burn or remove metal on a continuous basis, not having to reposition the electrode after only a short while in operation.

Product is fed continuously from large spools (i.e., 60 lb coils or 500 lb drums) as with MIG welding wire.

The ability to use standard welding machine along with compressed air-no special holder is required.

The ability to remove narrow strips of metal at a rapid rate either completely through a plate or by gouging to certain depths.

Plate thickness, alloy content or depth is immaterial.

Noise level is reduced dramatically as compared to carbon-arc technology; sounds like a welding operation.

Carbon blow-by reduced dramatically providing a cleaner working environment, resulting in a more environmentally ‘green’ process.

No broken pieces or wasted electrodes which are common with standard product.

We claim:

1. Apparatus for cutting a metal substrate, comprising:
a hand-held unit;
a feeder operative to supply a wire through the hand-held unit, the wire including a carbon-containing core;
a source of electrical energy connected to the wire being fed and the metal to be cut such that an arc is created with sufficient energy to melt the metal in a localized region; and
apparatus for directing a gas to blow away the molten metal.

2. The apparatus of claim 1, wherein the hand-held unit, feeder and source of electrical energy form part of an existing metal-inert-gas (MIG) welder.

3. The apparatus of claim 1, wherein the gas is supplied through a body that clamps onto the hand-held unit of an existing metal-inert-gas (MIG) welder.

4. The apparatus of claim 1, wherein the carbon in the core of the wire is provided in the form of natural or synthetic graphite powder.

5. The apparatus of claim 1, further including an additive in the core of the wire to accelerate delivery force or enhance molten metal flow.

6. The apparatus of claim 1, wherein the wire core is surrounded with a mild steel jacket.

7. The apparatus of claim 1, wherein the gas is air.

8. The apparatus of claim 1, wherein the gas is oxygen.

9. Feedstock for metal cutting, operations, comprising:
a roll of wire having a mild steel jacket; and
a carbon-containing core.

10. The feedstock of claim 9, wherein the carbon in the core of the wire is provided in the form of natural or synthetic graphite powder.

11. The feedstock of claim 9, further including an additive in the core of the wire to accelerate delivery force or enhance molten metal flow.

12. A method of converting a metal-inert-gas (MIG) welder into an efficient cutting machine, comprising the steps of:
removing the gas shield from the hand-held unit of the welder, exposing the contact tube;
positioning a body on the contact tube that direct a gas outwardly away from the hand-held unit;
replacing the welding wire of the welder with a wire having a carbon-containing core; and
energizing the welder such that a cutting arc is established between the wire and metal to be cut, with the gas being used to blow away molten particulates.
